(19) United States
(12) Patent Application Publication
(10) Pub. No.: US 2022/0129714 A1
(43) Pub. Date: Apr. 28, 2022

(54) LOT CODE INFORMATION FOR PRINTING DEVICE CALIBRATION

(71) Applicant: Hewlett-Packard Development Company, L.P., Spring, TX (US)

(72) Inventors: Naoto A. Kawamura, Vancouver, WA (US); Christine E. Steichen, San Diego, CA (US); Yifeng Wu, Vancouver, WA (US); John J. Cantrell, Vancouver, WA (US); David M. Wetchler, Vancouver, WA (US)

(73) Assignee: Hewlett-Packard Development Company, L.P., Spring, TX (US)

(21) Appl. No.: 17/296,232

(22) PCT Filed: Jul. 18, 2019
(86) PCT No.: PCT/US2019/042477

§ 371 Date: May 22, 2021

(51) Int. Cl. G06K 15/02; H04N 1/00

(52) U.S. Cl. CPC G06K 15/027; G06K 15/021; H04N 1/00761; H04N 1/00737; H04N 1/0023

(57) ABSTRACT

Examples of printing device calibration based on a lot code are described. In an example, a lot code of a print media is determined. Calibration parameters for a printing device are determined based on the lot code. The printing device is calibrated to print on the print media based on the calibration parameters.

### BACKGROUND

Printing devices may print on a print media. For instance, a printing device may process the print media to change the appearance of the print media. In some examples, the printing device may apply a print substance to the print media. In other examples, the printing device may cause changes (e.g., structural or chemical changes) within the print media. In some cases, the printing device may be calibrated to accurately print the print media.

### BRIEF DESCRIPTION OF THE DRAWINGS

Various examples will be described below by referring to the following figures.

FIG. 1 is a block diagram of an example of a printing device that may use a lot code for printing device calibration;

FIG. 2 is a flow diagram illustrating an example of a method for printing device calibration based on a lot code;

FIG. 3 is a flow diagram illustrating an example of a method for determining whether to calibrate a printing device calibration based on a lot code;

FIG. 4 is a flow diagram illustrating an example of a method for calibrating a printing device with calibration parameters printed on print media;

FIG. 5 is a flow diagram illustrating an example of a method for calibrating a printing device with calibration parameters obtained from an external device;

FIG. 6 is a flow diagram illustrating an example of a method for calibrating a printing device with calibration parameters obtained from a calibration parameter database; and

FIG. 7 illustrates another example of a printing device that may read a lot code on a print media for printing device calibration.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations in accordance with the description; however, the description is not limited to the examples and/or implementations provided in the drawings.

### DETAILED DESCRIPTION

The techniques described herein relate to printing device calibration using lot code information. As used herein a “lot code” is information that identifies a particular batch (i.e., lot) in which a print media was manufactured.

In some examples, a printing device—including thermal printers—may modify the structure of the print media to create an image (e.g., text or graphic image). In other examples, a printing device—including printers, copiers, fax machines, multifunction devices including additional scanning, copying, and finishing functions, all-in-one devices, and pad printers to print images on three dimensional objects—may apply a print substance, which can include printing agents or colorants, to a print media.

In some cases, the manufactured print media may have significant variation from one manufactured lot to another manufactured lot. This variation in print media due to manufacturing inconsistencies may result in inaccurate printing unless the printing device is calibrated to account for the print media variation. This disclosure relates to calibrating a printing device based on the lot code of a print media. Calibration parameters may be determined according to the specific properties of a print media lot.

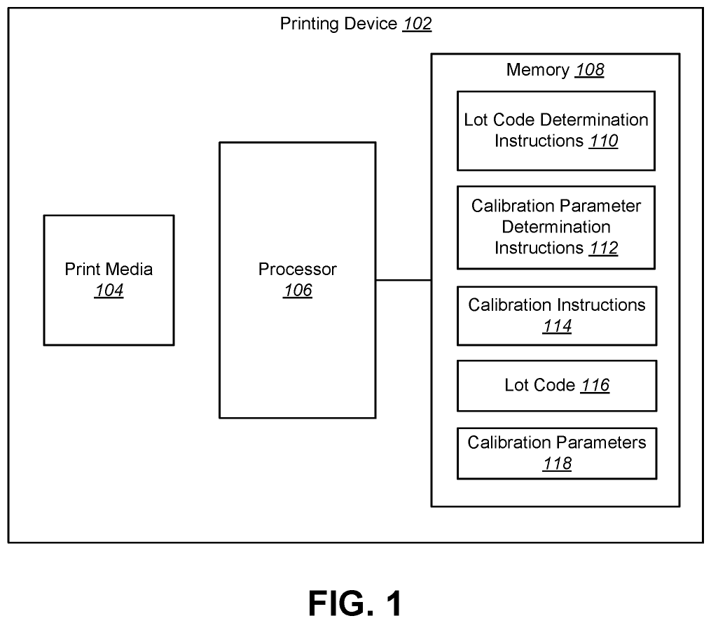

FIG. 1 is a block diagram of an example of a printing device 102 that may use a lot code 116 for printing device calibration. The printing device 102 may be an electronic device, such as a printing device, personal computer, a server computer, a smartphone, a tablet computer, etc. The printing device 102 may include and/or may be coupled to a processor 106 and/or a memory 108. In some examples, the printing device 102 may include a display and/or an input/output interface. In some examples, the printing device 102 may be in communication with (e.g., coupled to, have a communication link with) an external device (e.g., smartphone, personal computer, a server computer, a smartphone, a tablet computer, etc.). The printing device 102 may include additional components (not shown) and/or some of the components described herein may be removed and/or modified without departing from the scope of this disclosure.

The processor 106 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 108. The processor 106 may fetch, decode, and/or execute instructions (e.g., lot code determination instructions 110, calibration parameter determination instructions 112 and/or calibration instructions 114) stored in the memory 108. In some examples, the processor 106 may include an electronic circuit or circuits that include electronic components for performing a function or functions of the instructions (e.g., lot code determination instructions 110, calibration parameter determination instructions 112 and/or calibration instructions 114). In some examples, the processor 106 may perform one, some, or all of the functions, operations, elements, methods, etc., described in connection with one, some, or all of FIGS. 1-6.

The memory 108 may be any electronic, magnetic, optical, or other physical storage device that contains or stores electronic information (e.g., instructions and/or data). The memory 108 may be, for example, Random Access Memory (RAM), Electrically Erasable Programmable Read-Only Memory (EEPROM), a storage device, an optical disc, and the like. In some examples, the memory 108 may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the memory 108 may be a non-transitory tangible machine-readable storage medium, where the term “non-transitory” does not encompass transitory propagating signals. In some examples, the memory 108 may include multiple devices (e.g., a RAM card and a solid-state drive (SSD)).

In some examples, the printing device 102 may include an input/output interface through which the processor 106 may communicate with an external device or devices (not shown), for instance, to receive and store information (e.g., a lot code 116 and/or calibration parameters 118) pertaining to a print media 104 to be printed. The input/output interface may include hardware and/or machine-readable instructions to enable the processor 106 to communicate with the external device or devices. The input/output interface may enable a wired or wireless connection to the external device or devices (e.g., personal computer, a server computer, a smartphone, a tablet computer, etc.). The input/output interface may further include a network interface card and/or may also include hardware and/or machine-readable instructions to enable the processor 106 to communicate with various input and/or output devices, such as a keyboard, a mouse, a display, a touchscreen, a microphone, a controller, another apparatus, electronic device, computing device, etc., through which a user may input instructions into the printing device 102.

The processor 106 may control motors and/or actuators (not shown) to control operations of the components of the printing device 102. For example, the processor 106 may control a motor (not shown) that moves the print media 104 through a print zone. The processor 106 may also control circuitry and other components of a printhead(s) (not shown). The processor 106 may further control components to determine a lot code 116 and/or calibration parameters 118.

In some cases, the manufactured print media 104 may have significant variation from one manufactured lot to another manufactured lot. In these cases, high variability in the print media production process may result in differences in one lot of print media as compared to another lot of print media. For example, some thermal-based printing technologies may use print media that varies significantly from one lot to another lot. To account for print media variation due to manufacturing inconsistencies, calibration parameters 118 may be pre-determined for each print media lot.

Calibration parameters 118 may be determined according to the specific properties of a print media lot. In some examples, the calibration parameters 118 may include a color curve specific to a manufactured batch of the print media 104. The calibration parameters 118 may indicate how the print media 104 responds to certain printing conditions. For example, in the case of thermal printing, the print media 104 may include a layer or multiple layers that respond to temperature applied by the printing device 102. In this example, the calibration parameters 118 may characterize how the print media 104 will respond to temperature and time.

In an approach, a pack of print media may include a separate calibration sheet of paper that includes calibration data. To calibrate the printing device in this approach, the user may ensure that the separate calibration sheet is installed properly in the printing device along with the rest of the print media from the pack. The printing device may scan the separate calibration sheet to determine the calibration parameters. The printing device then ejects the separate calibration sheet before printing on the print media.

In this approach, if a user changes print media to a new pack, the user needs to load the separate calibration sheet for the new pack of print media to get the correct colors. In an example, a user may switch packs of print media before finishing a first pack of print media. Then, if the user wishes to switch back to the first pack of print media, the user may have already lost or disposed of the original calibration sheet for that pack of print media.

In other approaches, the examples described herein provide for printing device calibration based on a lot code 116. In some examples, the processor 106 may execute the lot code determination instructions 110. For example, the processor 106 may determine the lot code 116 of a print media 104. The lot code 116 may indicate a manufactured batch (also referred to as the lot) of the print media 104. For example, the lot code 116 may be encoded information that indicates a group of print media that was manufactured in the same batch. The lot code 116 may also be referred to as a lot number or batch number.

In some examples, the lot code 116 may be applied to or integrated with each piece of print media 104 that is printed by the printing device 102. For example, a discrete piece of print media 104 (e.g., a print media sheet) may include its lot code 116.

In some examples, the lot code 116 may be printed on the print media 104. For example, the lot code 116 may be printed on a back side of the print media 104. In another example, the lot code 116 may be printed on a front side of the print media 104. In yet another example, the lot code 116 may be printed on both a front side and the back side of the print media 104.

In an example, the lot code 116 may be a barcode. In some examples, the lot code 116 may be a linear barcode or a matrix barcode. In other examples, the lot code 116 may be in another coding format that is readable by the printing device 102.

In some examples, the lot code 116 may be communicated using circuitry integrated with the print media 104. For example, the print media 104 may include an RFID tag that communicates the lot code 116 to the printing device 102.

In some examples, the processor 106 may determine the lot code 116 of the print media 104 by causing the printing device 102 to scan the lot code 116. In the case of a barcode, the printing device 102 may include a scanning component (e.g., barcode reader) to scan the lot code 116. Scanning the lot code 116 may include decoding the scanned barcode to determine the value of the lot code 116.

In an example, the lot code 116 may be printed on each piece of print media 104. The processor 106 may cause the printing device 102 to scan the lot code 116 before each piece of print media 104 is printed. In some implementations, the lot code 116 may be printed on a first region of the print media 104 to enter the print zone. In this implementation, the lot code 116 may be scanned before the printhead begins printing the print media 104.

In some examples, the processor 106 may execute the calibration parameter determination instructions 112 to determine calibration parameters 118 for the printing device 102 based on the lot code 116. As described above, the calibration parameters 118 may be a pre-determined color curve specific to a manufactured batch of the print media 104 associated with the lot code 116. In other examples, the calibration parameters 118 may be other pre-determined data including thickness or a threshold used for printing. For instance, the calibration parameters 118 may include energizing parameters (indicated by the pre-determined color curve, thickness, threshold, etc.) used to print accurate colors or monochrome (e.g., grayscale) within or upon the print media 104. The lot code 116 may indicate which calibration parameters 118 should be applied for the print media 104.

In an example, the processor 106 may determine whether the lot code 116 of the current print media 104 is different than the lot code 116 of the previous print media 104 printed before the current print media 104. In other words, the processor 106 may determine whether the current print media 104 is from the same lot as the last piece of print media 104 to be printed. If the lot code 116 is the same as the last piece of print media 104, the processor 106 will continue to use the same calibration parameters 118 for the current print media 104. If the lot code 116 of the current print media 104 differs from the lot code 116 of the previously printed print media 104, then the processor 106 may proceed with determining (e.g., acquiring) the calibration parameters 118 for the current print media 104.

In another example, the processor 106 may determine the calibration parameters 118 for each piece of print media 104 to be printed. In other words, in this example, the processor 106 may determine (e.g., acquire) the calibration parameters 118 for the current print media 104 regardless of whether the lot code 116 of the current print media 104 differs from the lot code 116 of the previously printed print media 104.

In one approach, the processor 106 may determine the calibration parameters 118 by causing the printing device 102 to scan calibration parameters 118 printed on the print media 104. In this example, the calibration parameters 118 may be located on each piece of print media 104. For instance, the calibration parameters 118 may be printed on each piece of print media 104. In this case, the calibration parameters 118 may be encoded in a format (e.g., barcode) that is readable by the printing device 102. In one approach, the calibration parameters 118 may be a separate barcode from the lot code 116. In another approach, the lot code 116 and the calibration parameters 118 may be included in a single barcode.

In an example of this approach, the printing device 102 may feed the print media 104 through the print zone without printing. While the print media 104 passes through the print zone, a scanning component may scan the calibration parameters 118 printed on the print media 104. The printing device 102 may then reverse the print media 104 back through the print zone before printing the print media 104.

In another approach, the processor 106 may determine the calibration parameters 118 by sending the lot code 116 to an external device and receiving the calibration parameters 118 from the external device. For example, the printing device 102 may be in communication with an external device. The printing device 102 may be connected to the external device via a wireless connection (e.g., Bluetooth, WiFi, etc.) or a wired connection. Examples of the external device include a personal computer, a server computer, a smartphone, a tablet computer, etc.). The printing device 102 may send the lot code 116 to the external device.

In some examples, the external device may include a database of calibration parameters 118 for different lot codes 116. For instance, the external device may be preconfigured with a number of calibration parameters 118 for different lot codes 116. Upon receiving the lot code 116 from the printing device 102, the external device may query the calibration parameter database to determine the calibration parameters 118 specific to that lot code 116. The external device may then send the calibration parameters 118 back to the printing device 102.

In another example, the external device may obtain the calibration parameters 118 from a remote server. For example, a smartphone may receive the lot code 116 from the printing device 102. The smartphone may forward the lot code 116 to a remote server (e.g., cloud server), which returns the calibration parameters 118 for that lot code 116 to the smartphone. The smartphone may then send the calibration parameters 118 to the printing device 102.

In yet another approach, the processor 106 may determine the calibration parameters 118 by querying a calibration parameter database stored on the printing device 102. In this approach, the calibration parameter database may be stored on the printing device 102 instead of an external device. The calibration parameter database may include a number of different calibration parameters 118 corresponding to different lot codes 116. Using the lot code 116 determined from the current print media 104, the processor 106 may query the calibration parameter database to determine which calibration parameters 118 to use.

In some examples, the calibration parameter database may be preconfigured (e.g., pre-installed) on the printing device 102. In other examples, the printing device 102 may receive updates to the calibration parameter database. For example, the calibration parameter database may be transferred to the printing device 102 either through a firmware update or as a file transfer from an external device.

In some examples, the processor 106 may implement a combination of these approaches to determine the calibration parameters 118. For example, the processor 106 may first attempt to query a calibration parameter database stored on the printing device 102. If the printing device 102 does not have a calibration parameter database or if the calibration parameter database does not have calibration parameters 118 for a given lot code 116, then the processor 106 may attempt to determine the calibration parameters 118 from an external device. If this attempt is unsuccessful, then the processor 106 may scan the calibration parameters 118 printed on the print media 104.

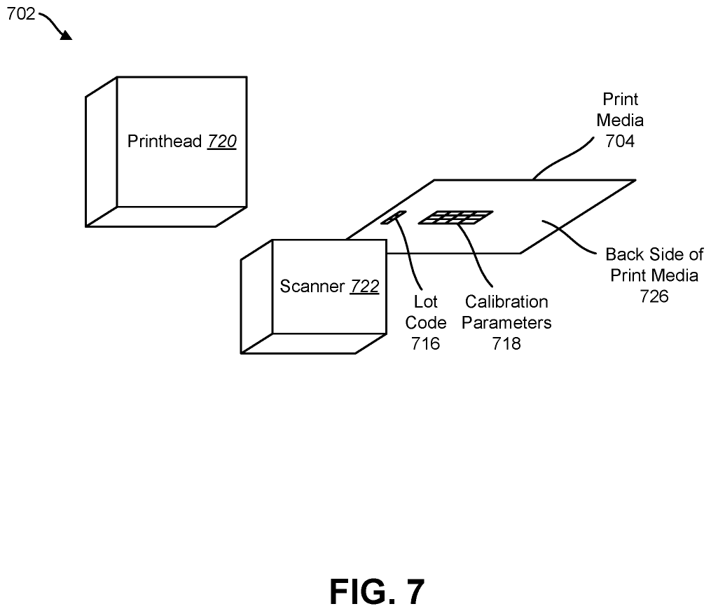

In some examples, the position and size of the lot code 116 on the print media 104 may allow the lot code 116 to be read during movement of the print media 104 through the printing device 102 prior to printing. The position and size of the lot code 116 on the print media 104 may allow the processor 106 to ensure that the correct calibration parameters 118 are applied. Furthermore, the position and size of the lot code 116 on the print media 104 may allow the processor 106 to avoid reading full calibration data on each print if multiple consecutive pieces of print media 104 have the same lot code 116. An example of this approach is described in FIG. 7.

In some examples, the processor 106 may execute the calibration parameter determination instructions 112 to calibrate the printing device 102 to print on the print media 104 based on the calibration parameters 118. For example, upon determining the calibration parameters 118 using the lot code 116 of the print media 104, the printing device 102 may apply the pre-determined color curve specific to a manufactured batch of the print media 104 associated with (e.g., indicated by) the lot code 116. In an example, calibrating the printing device 102 may include applying energizing parameters (e.g., time and/or temperature) used to print accurate colors or monochrome (e.g., grayscale) within or upon the print media 104. In other examples, calibrating the printing device 102 may include applying print settings specific to the lot of the print media 104.

In some examples, the printing device 102 may be calibrated with the calibration parameters 118 if the lot code 116 indicates that the print media 104 is from a different lot than a previous print media 104. In this case, if the current lot code 116 is the same as the lot code 116 of the last piece of print media 104 to be printed, the printing device 102 may skip recalibration and may proceed directly to printing the print media 104.

In other examples, the printing device 102 may be calibrated with the calibration parameters 118 each time a piece of print media 104 is printed. In other words, the processor 106 may cause the printing device 102 to be recalibrated with the calibration parameters 118 associated with the lot code 116 for the current print media 104 regardless of whether the lot code 116 of the current print media 104 differs from the lot code 116 of the previously printed print media 104.

This use of a lot code 116 for printing device calibration enables the user to obtain the best print quality (e.g., color) for a given piece of print media 104. Furthermore, the user of the printing device 102 does not need to use a separate calibration sheet to calibrate the printing device 102.

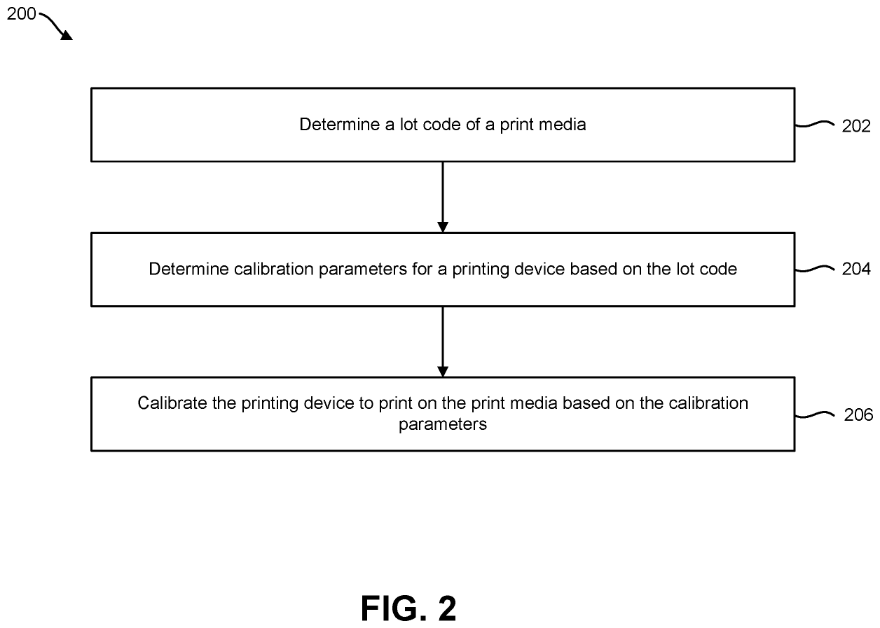

FIG. 2 is a flow diagram illustrating an example of a method 200 for printing device calibration based on a lot code 116. The method 200 for printing device calibration based on a lot code 116 may be performed by, for example, the processor 106 of a printing device 102.

The processor 106 may determine 202 a lot code 116 of a print media 104. For example, the lot code 116 may indicate a manufactured batch of the print media 104. In some examples, the lot code 116 may be printed on the print media 104. For instance, the lot code 116 may be a barcode printed on the back side of a sheet of print media 104. In this case, the processor 106 may cause the printing device 102 to scan the lot code 116 on the print media 104. In some examples, the lot code 116 may be scanned for each piece of print media 104 printed by the printing device 102. For example, before printing a piece of print media 104, the processor 106 may cause the printing device 102 to scan the lot code 116 on the print media 104.

The processor 106 may determine 204 calibration parameters 118 for the printing device 102 based on the lot code 116. For example, the processor 106 may determine (e.g., obtain) a pre-determined calibration parameters specific to a manufactured batch of the print media 104 associated with the lot code 116. In some examples, the calibration parameters 118 may include energizing parameters used to print accurate colors within the print media 104.

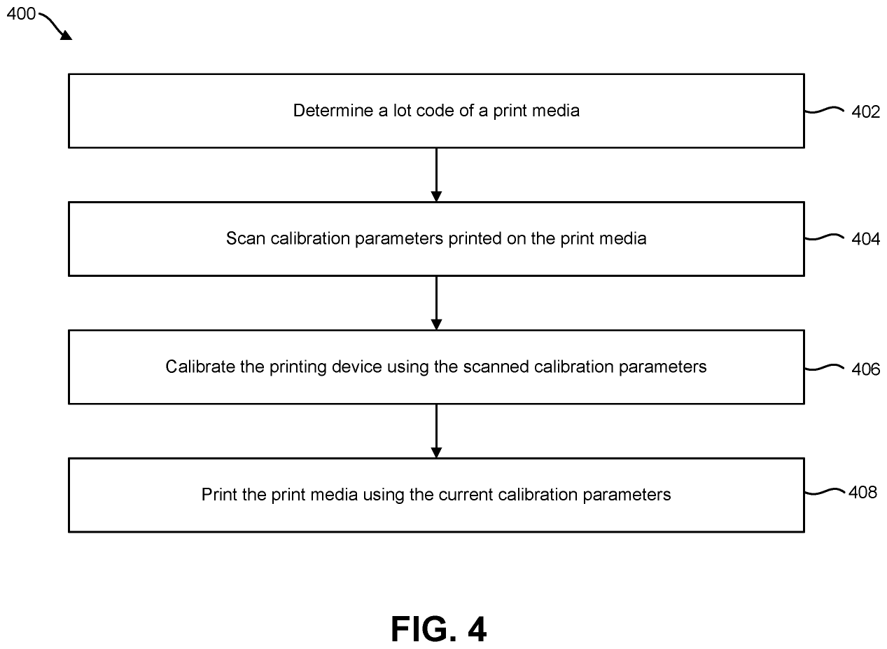

In one example, the processor 106 may determine 204 the calibration parameters 118 by scanning the calibration parameters 118 printed on the print media 104. This approach is described in FIG. 4.

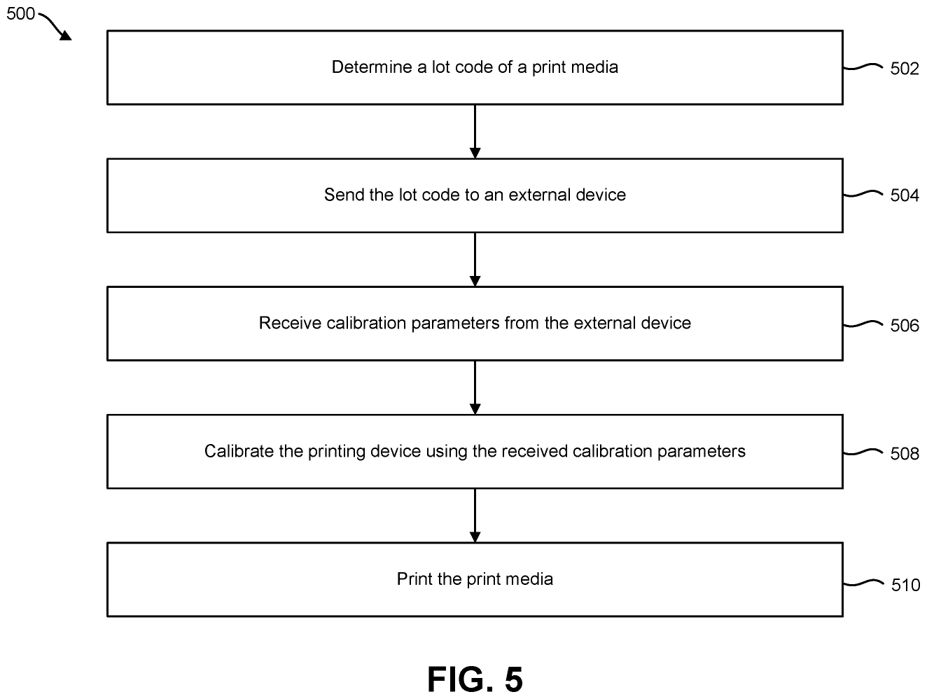

In another example, the processor 106 may determine 204 the calibration parameters 118 by sending the lot code 116 to an external device and receiving the calibration parameters 118 from the external device. This approach is described in FIG. 5.

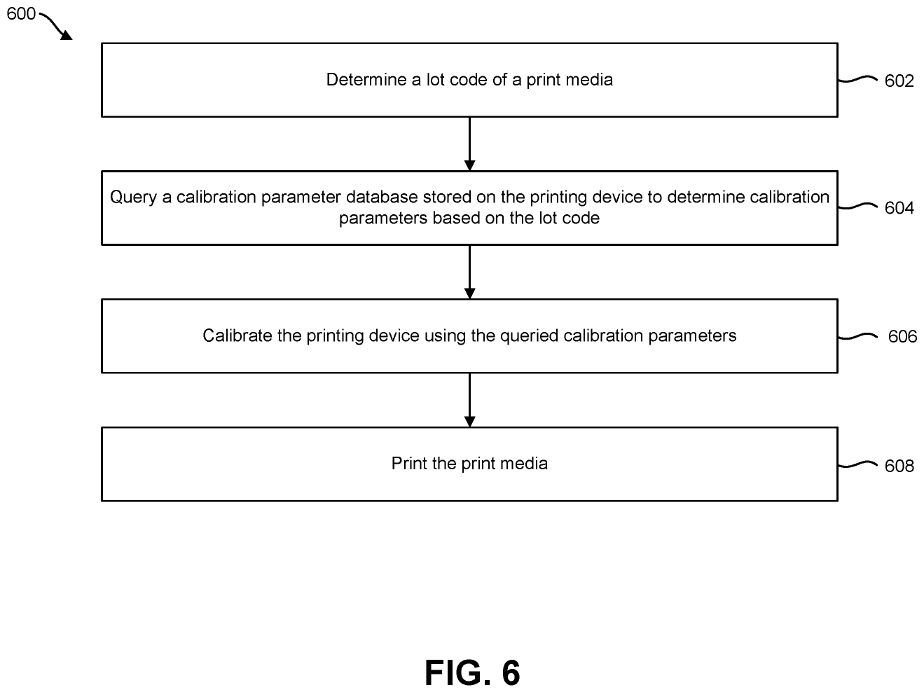

In yet another example, the processor 106 may determine 204 the calibration parameters 118 by querying a calibration parameter database stored on the printing device 102 based on the lot code 116. This approach is described in FIG. 6.

The processor 106 may calibrate 206 the printing device 102 to print on the print media 104 based on the calibration parameters 118. For example, calibrating 206 the printing device 102 may include applying energizing parameters used to print accurate colors within the print media 104.

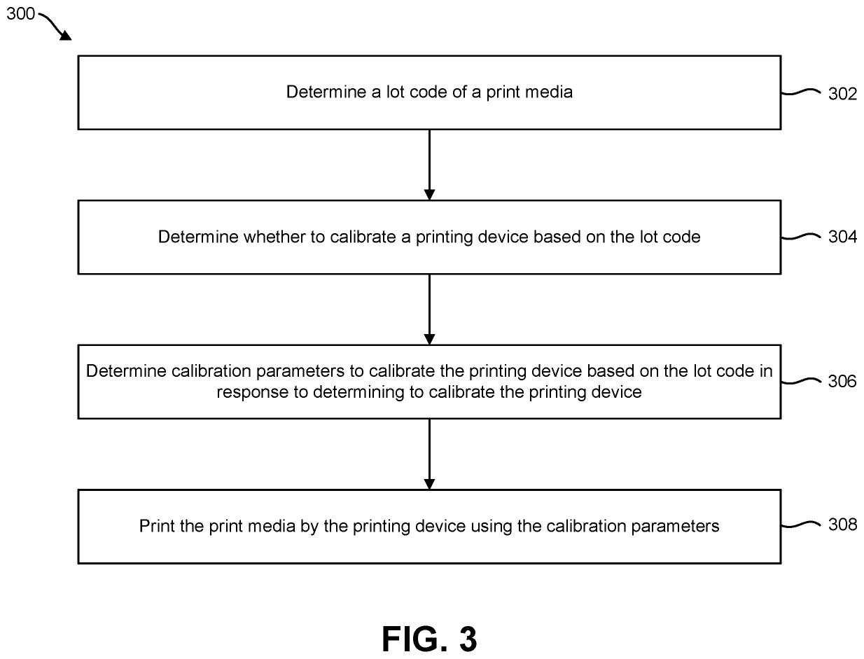

FIG. 3 is a flow diagram illustrating an example of a method 300 for determining whether to calibrate a printing device 102 calibration based on a lot code 116. The method 300 for printing device calibration may be performed by, for example, the processor 106 of a printing device 102.

The processor 106 may determine 302 a lot code 116 of a print media 104. This may be accomplished as described in FIG. 1 and FIG. 2. In some examples, the lot code 116 may be determined for each piece of print media 104 printed by the printing device 102. In some examples, the position and size of the lot code 116 on the print media 104 may allow the lot code 116 to be read during movement of the print media 104 through the printing device 102 prior to printing.

The processor 106 may determine 304 whether to calibrate the printing device 102 based on the lot code 116. In some examples, determining 304 to calibrate the printing device 102 may include determining that the lot code 116 of the print media 104 differs from a lot code 116 of a previously printed print media. In other words, if the processor 106 determines that the current print media 104 is from the same lot as the last piece of print media 104 to be printed, then the processor 106 may use the same calibration parameters 118 as the previous print operation. In this case, the printing device 102 may print the print media 104 without recalibration. However, if the lot codes 116 differ, then the processor 106 may determine 304 that the printing device 102 is to be calibrated with calibration parameters 118 for the current lot code 116.

In other examples, the processor 106 may determine 304 that the printing device 102 is to be calibrated with the calibration parameters 118 associated with the current lot code 116 each time a piece of print media 104 is printed. In other words, the processor 106 may cause the printing device 102 to be recalibrated with the calibration parameters 118 associated with the lot code 116 for the current print media 104 regardless of whether the lot code 116 of the current print media 104 differs from the lot code 116 of the previously printed print media 104.

In response to determining to calibrate the printing device 102, the processor 106 may determine 306 calibration parameters 118 for the printing device 102 based on the lot code 116. This may be accomplished as described in connection with FIG. 1 and FIG. 2.

The processor 106 may cause the printing device 102 to print 308 the print media 104 using the calibration parameters 118. For example, the processor 106 may apply energizing parameters used to print accurate colors within the print media 104. The printing device 102 may print 308 the print media 104 using the reconfigured calibration parameters 118.

FIG. 4 is a flow diagram illustrating an example of a method 400 for calibrating a printing device 102 with calibration parameters 118 printed on print media 104. This method 400 for printing device calibration may be performed by, for example, the processor 106 of a printing device 102.

The processor 106 may determine 402 a lot code 116 of a print media 104. This may be accomplished as described in FIG. 1 and FIG. 2. In some examples, the lot code 116 may be determined for each piece of print media 104 printed by the printing device 102. In some examples, the lot code 116 may be scanned from the print media 104.

The processor 106 may cause the printing device 102 to scan 404 calibration parameters 118 printed on the print media 104. In this example, the calibration parameters 118 may be located on each piece of print media 104. For instance, the calibration parameters 118 may be printed on each piece of print media 104. In this case, the calibration parameters 118 may be encoded in a format (e.g., barcode) that is readable by the printing device 102. In one approach, the calibration parameters 118 may be a separate barcode from the lot code 116. In another approach, the lot code 116 and the calibration parameters 118 may be included in a single barcode. The printing device 102 may scan the calibration parameters 118 located on the print media 104 before printing the print media 104.

The processor 106 may calibrate 406 the printing device 102 using the scanned calibration parameters 118. For example, upon scanning the calibration parameters 118 from the print media 104, the processor 106 may calibrate 406 the printing device 102 by applying the scanned calibration parameters 118. In some examples, the calibration 406 may include applying energizing parameters used to print accurate colors within the print media 104. Upon calibrating the printing device 102, the processor 106 may cause the printing device 102 to print 408 the print media 104 using the current calibration parameters 118.

FIG. 5 is a flow diagram illustrating an example of a method 500 for calibrating a printing device 102 with calibration parameters 118 obtained from an external device. This method 500 for printing device calibration may be performed by, for example, the processor 106 of a printing device 102.

The processor 106 may determine 502 a lot code 116 of a print media 104. This may be accomplished as described in FIG. 1 and FIG. 2.

The processor 106 may send 504 the lot code 116 to an external device. For example, the printing device 102 may be in communication with the external device. The printing device 102 may be connected to the external device via a wireless connection (e.g., Bluetooth, WiFi, etc.) or a wired connection. Examples of the external device include personal computer, a server computer, a smartphone, a tablet computer, etc.).

The processor 106 may receive 506 calibration parameters 118 from the external device. In some examples, the external device may include a database of calibration parameters 118 for different lot codes 116. The external device may query the calibration parameter database to determine the calibration parameters 118 specific to the lot code 116 sent by the printing device 102. The external device may then send the calibration parameters 118 back to the printing device 102. In other examples, the external device may obtain the calibration parameters 118 from a remote server and then sends the calibration parameters 118 back to the printing device 102.

The processor 106 may calibrate 508 the printing device 102 using the received calibration parameters 118. For example, upon receiving the calibration parameters 118 from the external device, the processor 106 may calibrate 508 the printing device 102 by applying the received calibration parameters 118. Upon calibrating the printing device 102, the processor 106 may cause the printing device 102 to print 510 the print media 104 using the received calibration parameters 118.

FIG. 6 is a flow diagram illustrating an example of a method 600 for calibrating a printing device 102 with calibration parameters 118 obtained from a calibration parameter database. This method 600 for printing device calibration may be performed by, for example, the processor 106 of a printing device 102.

The processor 106 may determine 602 a lot code 116 of a print media 104. This may be accomplished as described in FIG. 1 and FIG. 2.

The processor 106 may query 604 a calibration parameter database stored on the printing device 102 to determine the calibration parameters 118 based on the lot code 116. The calibration parameter database may include a number of different calibration parameters 118 corresponding to different lot codes 116. Using the lot code 116 determined from the current print media 104, the processor 106 may query 604 the calibration parameter database to determine which calibration parameters 118 to use. In other words, the processor 106 may look up the calibration parameters 118 in the calibration parameter database using the lot code 116 of the print media 104.

The processor 106 may calibrate 606 the printing device 102 using the queried calibration parameters 118. For example, upon querying the calibration parameter database using the lot code 116 to obtain the calibration parameters 118, the processor 106 may calibrate 606 the printing device 102 by applying the queried calibration parameters 118. Upon calibrating the printing device 102, the processor 106 may cause the printing device 102 to print 608 the print media 104 using the queried calibration parameters 118.

FIG. 7 illustrates another example of a printing device 702 that may read a lot code on a print media 704 for printing device calibration. In this example, the printing device 702 may include a printhead 720 and a scanner 722. The scanner 722 may be located ahead of the printhead 720 in the print path.

In some examples, the position and size of the lot code 716 on the print media 704 may allow the lot code 716 to be read during movement of the print media 704 through the printing device 702 prior to printing. In this example, the lot code 716 may be printed on the back side 726 of the print media 704. In other words, the lot code 716 may be located on a surface of the print media 704 that is opposite the surface that is to be printed by the printhead 720.

In some examples, the calibration parameters 718 may also be printed on the back side 726 of the print media 704. The calibration parameters 718 may be specific to the lot code 716 of the print media 704.

In some examples, the lot code 716 and the calibration parameters 718 may be barcodes. The lot code 716 may be a first barcode that is read by the scanner 722 before the second barcode of the calibration parameters 718.

The lot code 716 may be located at a leading portion of the print media 704. Furthermore, the lot code 716 may be small enough that the scanner 722 may read (e.g., scan) the lot code 716 prior to printing. For example, the scanner 722 may read the lot code 716 on the print media 704 before the printhead 720 energizes to print the print media 704. In this manner, before energizing the printhead 720, the printing device 702 (e.g., processor 106 of FIG. 1) may determine whether to acquire and apply new calibration parameters 718 or to continue using the current calibration parameters 718.

In some examples, upon reading the lot code 716, the printing device 702 may acquire the calibration parameters 718 from a calibration parameter database. This may be accomplished as described in FIG. 1. If the printing device 702 successfully determines the calibration parameters 718 from the calibration parameter database, the printing device 702 may avoid reading the calibration parameters 718 printed on the print media 704. However, if acquiring the calibration parameters 718 from the calibration parameter database is unsuccessful, or if a calibration parameter database is unavailable, the printing device 702 may use the scanner 722 to read the calibration parameters 718 printed on the back side 726 of the print media 704.

The position and size of the lot code 716 on the print media 704 may allow the printing device 702 to ensure that the correct calibration parameters 718 are applied. Furthermore, the position and size of the lot code 716 on the print media 704 may allow the printing device 702 to avoid reading full calibration data (e.g., the printed calibration parameters 718) on each print if multiple consecutive pieces of print media 704 have the same lot code 716.

In some examples, the scanner 722 may have a very short time to read the lot code 716. For instance, the scanner 722 may have to finish reading the lot code 716 before the leading edge of the print media 704 reaches the printhead 720. Therefore, in some examples, the lot code 716 may be implemented as a short barcode. The scanner 722 may read only this short barcode before printing begins. The calibration parameters 718 may then be obtained by table look-up (e.g., looking up the lot code 716 in the calibration parameter database) or by scanning the calibration parameters 718 on the print media 704.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A method, comprising:
determining a lot code of a print media;
determining calibration parameters for a printing device based on the lot code; and
calibrating the printing device to print on the print media based on the calibration parameters.

2. The method of claim 1, wherein the lot code indicates a manufactured batch of the print media.

3. The method of claim 1, wherein the lot code is printed on the print media.

4. The method of claim 1, wherein determining calibration parameters for the printing device comprises determining a pre-determined calibration parameter specific to a manufactured batch of the print media associated with the lot code.

5. The method of claim 1, wherein calibrating the printing device comprises applying energizing parameters used to print accurate colors within the print media.

6. The method of claim 1, wherein the printing device is calibrated with the calibration parameters if the lot code indicates the print media is from a different lot than a previous print media.

7. A printing device, comprising:
a memory;
a processor coupled to the memory, wherein the processor is to:
scan a lot code printed on a print media;
determine calibration parameters for a printing device based on the lot code; and
calibrate the printing device to print on the print media based on the calibration parameters.

8. The printing device of claim 7, wherein the lot code is printed on a back side of the print media.

9. The printing device of claim 7, wherein the lot code is scanned for each piece of print media printed by the printing device.

10. The printing device of claim 7, wherein determining the calibration parameters comprises scanning the calibration parameters printed on the print media.

11. The printing device of claim 7, wherein determining the calibration parameters comprises:
sending the lot code to an external device; and
receiving the calibration parameters from the external device.

12. The printing device of claim 7, wherein determining the calibration parameters comprises:
querying a calibration parameter database stored on the printing device to determine the calibration parameters based on the lot code.

13. A method, comprising:
determining a lot code of a print media at a printing device;
determining whether to calibrate the printing device based on the lot code;
determining calibration parameters to calibrate the printing device based on the lot code in response to determining to calibrate the printing device; and
printing the print media by the printing device using the calibration parameters.

14. The method of claim 13, wherein a position and size of the lot code on the print media allows the lot code to be read during movement of the print media through the printing device prior to printing.

15. The method of claim 13, wherein determining to calibrate the printing device comprises determining that the lot code of the print media differs from a lot code of a previously printed print media.
